(19) United States
(12) Patent Application Publication
(10) Pub. No.: US 2013/0267163 A1
(43) Pub. Date: Oct. 10, 2013

(54) COMMUNICATIONS SECURITY IN MULTIPLE-ANTENNA WIRELESS NETWORKS

(71) Applicants: Narendra Anand, Houston, TX (US); Sung-Ju Lee, Redwood City, CA (US); Edward Knightly, Houston, TX (US)

(72) Inventors: Narendra Anand, Houston, TX (US); Sung-Ju Lee, Redwood City, CA (US); Edward Knightly, Houston, TX (US)

(21) Appl. No.: 13/440,793

(22) Filed: Apr. 5, 2012

(51) Int. Cl. H04W 12/02; H04W 84/12; H04K 3/00

(52) U.S. Cl. 455/1

(57) ABSTRACT

A system enhances communications security in a wireless local area network (WLAN). The system includes a multiple antenna array arranged to transmit and receive signals; and a transmitter/receiver coupled to the multiple antenna array and configured to transmit and receive the signals. The transmitter/receiver includes a beamformer, which in turn includes a signal processor component that generates a signal beam for transmission to an intended user, and a blinding component that computes one or more blinding beams using only channel state information of the intended user. The blinding beams have a zero inter-user interference condition with the signal beam. The transmitter/receiver transmits the signal beam and the blinding beams simultaneously

### BACKGROUND

Wireless communications are susceptible to eavesdropping. For example, IEEE 802.11 is a wireless communications standard that has been adopted in a variety of environments. IEEE 802.11n is an amendment to the original IEEE standards by adding multiple-input multiple-output antennas (MIMO). Wireless networks following the IEEE 802.11n standard operate on both the 2.4 GHz and the lesser used 5 GHz bands. Wireless networks based on the IEEE 802.11 standard can be found in homes, offices, and business environments. If sensitive information is transmitted over these wireless networks, communications privacy and security may be compromised unless effective measures are taken to guard against eavesdropping.

### DESCRIPTION OF THE DRAWINGS

The detailed description will refer to the following drawings in which like numerals refer to like items, and in which:

FIG. 1 illustrates a wireless communications environment;

FIG. 2 illustrates a wireless communications environment in which an embodiment of a spatial signal processing system is implemented to enhance wireless communications security with wireless devices having multiple antennas;

FIG. 3 is a block diagram illustrating the spatial signal, processing system of FIGS. 2; and

FIG. 4 is a flow chart illustrating an embodiment of an operation of the spatial signal processing system of FIG. 2.

### DETAILED DESCRIPTION

Wireless communications, such as those conforming to Institute of Electronics and Electrical and Electronics Engineers (IEEE) standards, are susceptible to eavesdropping. For example IEEE 802.11 is a wireless communications standard that has been adopted in a variety of environments. The IEEE 802.11n standard improves upon the previous IEEE 802.11 standards by adding multiple-input multiple-output antennas (MIMO). The IEEE 802.11n standard operates on both the 2.4 GHz and the lesser used 5 GHz bands. IEEE 802.11ac1 is a follow-on standard. Wireless networks based on the IEEE 802.11 standard can be found in homes, offices, and business environments. However, these standards do not address communications security. If sensitive information is transmitted over these wireless networks, communications privacy and security may be compromised unless effective measures are taken to guard against eavesdropping.

Thus, the broadcast nature of wireless communication necessitates the development and use of robust security measures to thwart eavesdroppers from intercepting transmissions directed toward an intended user. One such measure is encryption. However, while encryption mitigates this vulnerability, even industry standard encryption methods such as Wired Equivalent Privacy (WEP) and Wi-Fi Protected Access (WPA) may be compromised, and readily available software packages enable malicious users to defeat networks that employ encryption. Another measure for enhancing the security of wireless transmission s is to prevent the eavesdropper from receiving or decoding the transmitted signal. A specific example of such a measure involves a directional transmission scheme that focuses signal energy toward an intended receiver using a directional antenna, switched-beam, or a single-target adaptive beamforming transmission. When a transmitter or receiver or both perform beamforming, the transmitted/received signal is contained in a specific region between the transmitter and receiver, where the region is defined by the shape and magnitude of the beam patterns and the channel used for the transmission. However, in practice, such techniques, which depend on the predictable behavior of the transmitted beam patterns or that are agnostic to the entire eavesdropper environment, often fail to prevent eavesdropping.

Disclosed is a spatial signal processing system, and method implemented with that system, that improves wireless communications security. The system and method can be used in any range of the wireless spectrum. In one embodiment, the system is a multi-antenna, 802.11-compatible system. The system, which adaptively sends a transmit signal, to an intended user using a spatially configured beam (referred to hereafter as a “signal beam”) while simultaneously transmitting one or more “blinding beams” that actively interfere with potential eavesdroppers. Moreover, the construction and generation of the signal beam (that is sent to the intended user), and the construction and generation of the blinding beams is based solely of the intended user's channel information and requires no knowledge of the potential eavesdroppers, and no knowledge of, or cooperation from, any other wireless device or component. That is, the beamforming processes depends solely on the transmitting access point and one intended user. In one embodiment, the system uses a Zero Forcing Beamforming (ZFBF) beamformer as a part of a ZFBF transmitter to generate beam steering weights to send a signal beam toward the intended user (recipient) while simultaneously transmitting one or more blinding beams in other directions. In another embodiment, the system uses other processes that approximate dirty paper coding to generate beam steering weights. In yet another embodiment, the system uses any applicable linear algebra-based method to generate beam steering weights. However, generated, in an embodiment, the blinding beams are approximately orthogonal to the signal beam. Moreover, in an embodiment, the system employs a beamforming engine and process that generates blinding beams that have zero interference with the signal beam. For ease of explanation, the system will be referred to hereafter as the STROBE (Simultaneous TRansmission with Orthogonally Blinded Eavesdroppers) system, although it should be apparent from the above discussion that exact orthogonality between the signal beam and the blinding beams is not required to achieve enhanced security in a wireless communications environment.

The STROBE system can be used to simultaneously transmit signal beams (i.e., intended signals) to multiple intended users while also transmitting one or more blinding beams. A limitation on the number of signal beams and blinding beams is the number of transmit antennas at the access point.

The STROBE system uses is a preceding method that enables a multi-antenna access point (AP) to create multiple simultaneous spatial streams in a wireless environment. Current communications systems that conform to wireless standards such as the IEEE 802.11n or upcoming standards such as the IEEE 802.11ac1 employ physical layers (PHYs) that can implement the STROBE system to construct multiple parallel transmission streams to a single user (recipient) (IEEE 802.11n) or simultaneously to multiple users (IEEE 802.11ac). Because such existing communications systems are able to create multiple parallel streams, the STROBE system can be implemented in these systems with only access point (AP) modifications and with no client (i.e., user) modifications. The STROBE system also can be used with WEP or WPA encryption methods to further enhance wireless communications security.

In an embodiment, the STROBE system and its larger transmitter is implemented in an FPGA-based software defined radio platform. One specific alternative is a radio card found in a lap top computer. As will be discussed later, the efficacy of the STROBE system for securing wireless communications is superior to other transmission mechanisms such as omnidirectional beamforming and use of a directional antenna. The STROBE system also provides superior security performance in the unrealistic scenario in which eavesdroppers “cooperate” (“Cooperating Eavesdroppers” (CE)) by providing the channel information of their wireless device to the STROBE system. While in practice, eavesdroppers would never actively, aid in blocking their eavesdropping by providing such channel information, the CE scenario provides a “benchmark” for blinding eavesdroppers.

The STROBE system takes advantage of multi-path environments (e.g., indoors, outdoor locations with physical obstacles), which are the common environments for IEEE 802.11-based networks. In such an environment, the STROBE system controls leaked signal energy from multi-path effects to actively thwart eavesdroppers by transmitting simultaneous interference streams. The simultaneous interference streams severely diminish eavesdropping. Even in the (unrealistic) Cooperating Eavesdropper scheme, as will be described later, the STROBE system realizes a sufficient signal energy difference between the intended user and the eavesdropper to thwart eavesdropping.

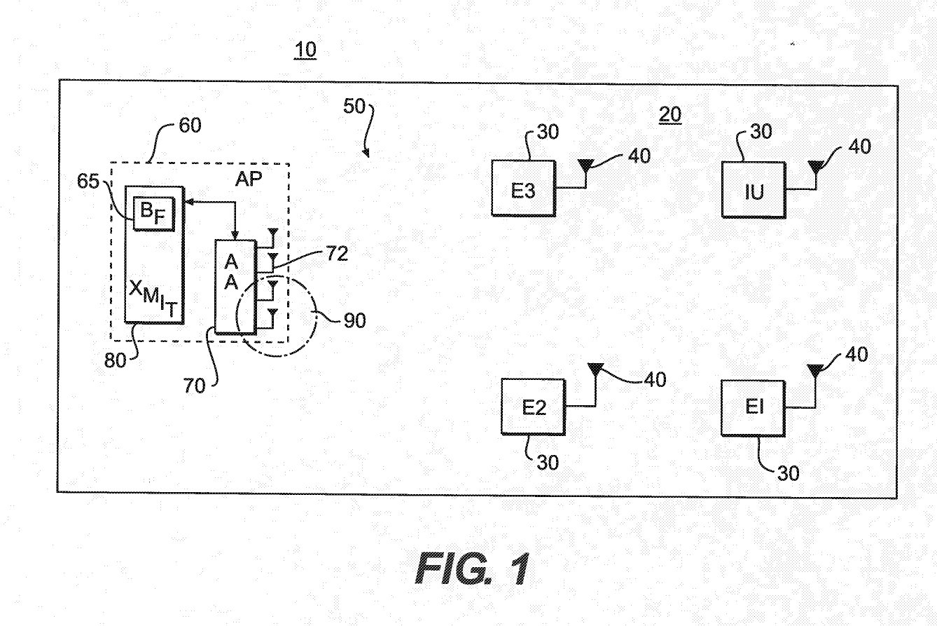

FIG. 1 illustrates a multi-path environment in which is established a wireless local area network (WLAN) that is compliant with IEEE 802.11x, and in which the disclosed system and method can be used to enhance wireless communications security. In particular, the system and method are able to send a signal beam to one or more intended users while simultaneously sending one or more Interfering or blinding beams to thwart potential eavesdroppers.

The environment of FIG. 1 a wireless communications system and a wireless local area network (WLAN) that has a multi-antenna AP and several users. In this disclosure, the term “user” refers to a wireless-enabled device, typically a mobile device, and does not refer to a human. Examples of users are lap top computers, tablets, and smartphones. Although the illustrated WLAN and its AP have the ability to support complex, multi-antenna technologies, the users (e.g. smartphones) may be limited to singular antenna designs and methods by constraints such as size, computational ability, and power consumption. A user, to which a transmission from the AP is intended is the “Intended User” (IU). Other users, who may overhear communications directed to the IU, are “Eavesdroppers” (E).

In FIG. 1, multi-path environment 10 is an indoor space (room) 20 in which are located four users 30. The users 30 may be Wi-Fi-enabled lap top computers, for example. Each user 30 includes antenna 40, which may receive and transmit wireless signals. Although the users 30 are shown with a single antenna 40, the users 30 could be configured with more than one antenna. A WLAN 50, which includes access point (AP) 60 (which could be referred to as a primary station or base station) is established at one end of the room 20. The AP 60 includes transmit antenna array 70. The antenna array 70 includes four antennas 72. Although the antenna array 70 is shown with four antennas, the antenna array 70 could be configured with 8 antennas, 16 antennas, or more. The antenna array 70 allows the AP 60 to form multiple beams or data streams, which may be transmitted simultaneously.

Coupled to the antenna array 70 is transmit device 80, which also may be a lap top computer, and which includes beamformer 65. The transmit device 80 may receive wireless communications from the users 30. Together, the antenna array 70, transmit device 80, beamformer 65, and antennas 72 form the AP 60.

The room 20 may be filled with metal objects (chairs, blinds, etc.—not shown) making the room 20 a multi-path rich environment. The users 30 are separated from each other and from the AP 60 One of the users 30 is an intended user (IU) and the other three users 30 are eavesdroppers (E1, E2, E3). The transmit device 80, antenna array 70, beamformer 65, and one of the transmit antennas 72 cooperate to generate signal 90, which in one alternative transmission mode is, as shown, an omnidirectional beam, and which is sent to the intended user (IU) 30.

The WLAN 50 may operate in a single user scheme, in which the AP 60 transmits to only one user IU 30 at a time, and in a multi-user scheme, in which the AP 60 transmits to more than one user IU 30 at the same time. The single user scheme can employ omnidirectional beams, non-adaptive directional beams, and single user beamforming (SUBF).

Omnidirectional transmission is common in many WLAN environments. In the environment 10, when omnidirectional transmission is used, the energy transmitted from one of the antennas 72 initially radiates equally in all directions, as shown (signal 90). However, the multi-path environment 10 ensures that some reflection will occur, and the actual signal strength at each of the antennas 40 will differ, not only because of the distance differences of these antenna from the transmit antenna 72, but also because of the multi-path effects. For example, in FIG. 1, because of the distance differences and multi-path arrivals, the signal to interference plus noise ratio (SINR) at the user 30 to which the transmission is intended (i.e., at IU 30), may be less than the SINR at any of the three eavesdroppers E1-E3. This SINR difference between the intended user IU and eavesdroppers E1-E3 reduces vulnerability of WLANs to eavesdropping when encryption protocols are not used, or when they are defeated. The omnidirectional transmission mode does not require any channel feedback from the user 30 to the transmit device 80.

Non-adaptive directional antenna transmission focuses energy where the signal beam is physically pointed and also does not require any channel feedback. Although beamforming methods used in non-adaptive directional antenna transmissions are aided by multi-path effects, an unwanted side effect is the potential for random signal reflections to increase SINRs at unintended locations (i.e., at the eavesdroppers E1-E3). The directional antenna's ability to passively focus energy in a particular direction allows the directional antenna to better cope with multi-path induced randomness seen in other schemes such as omnidirectional. Thus, an eavesdropper may receive a strong signal reflection for omnidirectional transmissions but a far weaker reflection for the directional antenna transmission. However, this ability does not make non-adaptive directional antenna transmissions immune to multi-path effects. The randomness caused by multi-path is simply constrained to the area where the antenna is aimed. That is, although the directional antenna scheme reduces multi-path effects outside of its beam pattern (sides of the room 20), the directional antenna scheme fails to do so where it is actually aimed. Additionally, the passive, directional transmission does not eliminate any overheard signal outside of its beam pattern because of the constrained nature of the typical indoor environment in which it is employed (e.g., the room 20 shown in FIG. 1). Thus, it is feasible for an eavesdropper to move toward the intended user IU looking for favorable signal strength.

The SUBF mode, unlike the omnidirectional and directional antenna schemes, uses channel estimates (h) that are provided from the users 30 to the transmit device;80. When these channel estimates are available at the transmit device 80, the signals fed by the transmit device 80 to each of the antennas 72 are weighted with suitable amplitude and phase components (i.e., beamforming weights w) to increase SINR at the users 30.

Finally, the WLAN 50 is capable of multi-user beamforming, in which multiple beams are provided to the users 30 with the goal of zero inter-user interference. That is, if the dot product of the two vectors h and w is zero: hₖwⱼ=0 for j≠k, then a zero interference condition is theoretically possible, but in practice, and exact zero interference condition may not occur due to various real-world effects. Examples of multi-user beamforming mechanisms include dirty paper coding and ZFBF, which approximates dirty paper coding. Even when a zero interference condition is satisfied, exactly or, more realistically, approximately, communications between the transmit device 80 and the users 30 may be compromised through eavesdropping by one of the users E1-E3. Thus, the use of ZFBF techniques to form non-interfering signal beams for simultaneous transmission to multiple users does not necessarily enhance communications security.

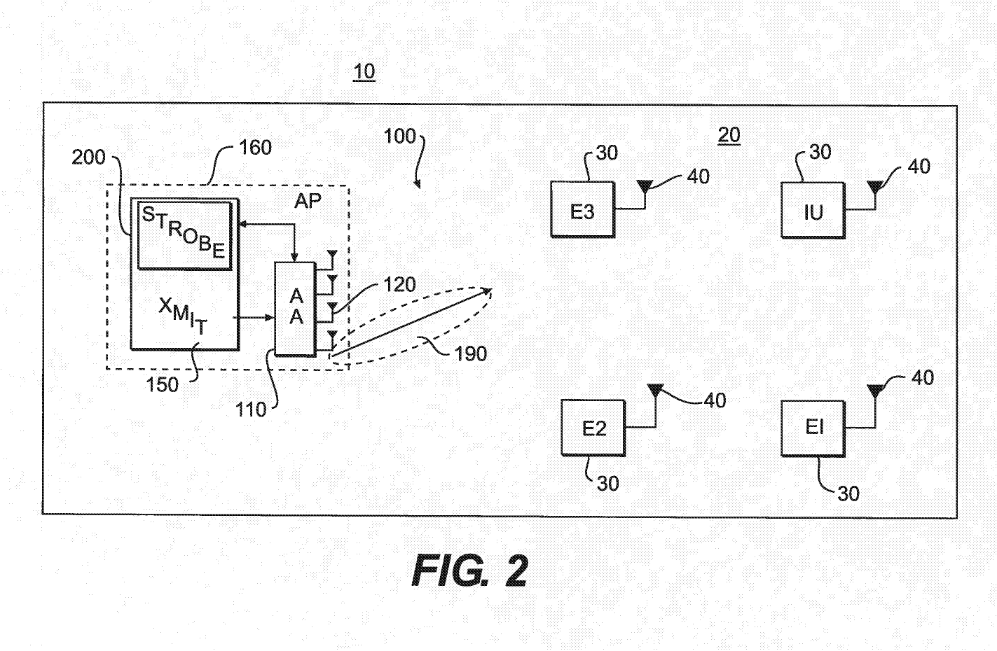

FIG. 2 illustrates a multi-path environment in which is established a wireless local area network (WLAN) that is compliant with IEEE 802.11x and in which spatial signal processing in multiple antenna wireless devices, and other similar and related beamforming mechanisms and methods may be deployed to enhance the security of wireless communications. In FIG. 2, multi-path environment 10 is the room 20 in which are located the four users 30. The users 30 may be Wi-Fi-enabled lap top computers, for example. Each user 30 includes receive antenna 40. A WLAN 100, which includes base station or access point (AP) 160 and antenna array 110, is established at one end of the room 20. The antenna array 110 includes four transmit antennas 120. Coupled to the antenna array 110 is transmit device 150, which also may be a lap top computer. The transmit device 150 incorporates STROBE system 200.

The antenna array 110 allows the AP 160 to form up to four beams of data streams, and the four beams can be sent simultaneously to four users 30. However, if the antenna array 110 included more than four antennas, then more users could be served, simultaneously. In an embodiment, in order to form the beam and establish a communication link, the STROBE system 200 generates precoding vectors, using information about the state of the communications channels (channel state information (CSI)) between the users 30 and the AP 160, and computations at both the user 30 and the AP 160. For example, a user 30 with a single receive antenna 40 feeds back the index of a single preferred precoding vector, which enables a better quality transmission or the most reliable communication, for example one which maximizes the ratio SINR at its antenna 40.

The room 20 is filled with metal objects (chairs, blinds, etc.—not shown) making the room 20 a multi-path rich environment. The users 30 are separated from each other and from the AP 160. One of the users 30 is an intended user (IU) and the other three users 30 are eavesdroppers (E1, E2, E3). The transmit device 150, antenna array 110, STROBE system 200, and a transmit antenna 120 cooperate to generate signal beam 190, which is a directional, or steered beam, and which is intended for the user (IU) 30, and to generate blinding beams (not shown in FIG. 2) that are orthogonal, or approximately orthogonal, to signal beam 190. By producing blinding beams that are orthogonal, or nearly orthogonal to the signal beam 190, the STROBE system 200 enhances security of the signal beam 190, as will be explained below.

As in the environment 10 of FIG. 1, in the environment 10 of FIG. 2, a fundamental adaptive signal energy direction technique that can be used in the WLAN 100 is Single-User Beamforming (SUBF). SUBF employs antenna array 110 to steer a beam toward an intended user based on that user's channel state information (CSI) (i.e., an h vector). That is, SUBF employs channel feedback (CSI) from the users 30. In effect, SUBF is a subset of ZFBF in that in SUBF, the number of “concurrent” users is one. Because there is only one intended user, the need for the zero-interference condition desired in multi-user beamforming does not exist (since there is no other stream to interfere with) so the weight selection results in the maximum possible received signal energy at the intended user (for a ZFBF type scheme). Because the H matrix consists of only one vector, the SUBF steering weight is simply W=(H_{1×N})^{‡}h^{‡}=h*. Thus, the intended user's steering weight for SUBF is its complex conjugate transpose, which is equivalent to the intended user's weight for ZFBF.

Despite the use of beamforming (e.g., ZFBF, dirty paper coding approximations, etc.) in the STROBE system 200, eavesdropper proximity or orientation relative to the intended user IU 30 has a negligible effect on the ability of the STROBE system 200 to serve the intended user IU 30 while blinding potential eavesdroppers E1-E3. That is, the STROBE system 200 does not appreciably degrade communications to the intended user IU 30. This is due in part to the fact that the STROBE system 200 exploits multi-path effects by harnessing signal reflections to reach the intended user IU 30. At a relative eavesdropper proximity of a quarter wavelength from the intended user IU 30, the STROBE system 200 still serves the intended user IU 30 with at least a stronger signal than the eavesdroppers E1-E3 receive.

The STROBE system 200 also ensures wireless communications security when a “nomadic” eavesdropper traverses an environment attempting to find a location to successfully eavesdrop. Even if the eavesdropper exhaustively traverses the environment (e.g., room 20), the STROBE system 200 still thwarts any eavesdropping. By contrast, eavesdroppers can very easily find suitable eavesdropping locations for other transmission schemes, including use of a directional antenna.

ZFBF is a downlink transmission technique used by the STROBE system 200 to compute beam steering weights so as to prevent interference between simultaneously transmitted signal beams that are aimed at (intended for) different users. The operation of STROBE 200 as it employs ZFBF in a novel way to blind eavesdroppers can be explained as follows. In FIG. 2, the AP 160 includes N transmit antennas; in the illustrated embodiment, the AP 160 has four transmit antennas. The AP 160 concurrently serves M single-antenna users; in this embodiment, four users 30. With this notation, a row vector hₘ a 1×N channel state vector for user m. Each element of the vector h corresponds to the complex exponential gain between one of the four transmit antennas 120 and the user m. The matrix H=[h₁; h₂; : : : ; h_{M}] is a M×N channel matrix constructed using each user's h vector (as noted above, the complex exponential gain between a transmit antenna and the user) as its rows. The column vector wₘ is an N×1 beam steering weight vector for user m. Each element of w corresponds to the complex exponential gain used by each transmitting antenna. The matrix W=[w₁ w₂ : : : wₘ] is the N×M beam steering weight matrix with each user's w as its columns. In the embodiment of FIG. 2, the matrices H and W are 4×4 matrices (four channels, four users).

The STROBE system 200 enables the system 100, which is already implementing ZFBF, to enhance communications security by the above-described binding beams methods. The STROBE system 200 receives from the users 30, each user's view of the channel, h, and constructs a corresponding w vector for each h vector. Each user's data stream is then multiplied by its corresponding summed together and transmitted over the AP's antenna array 110. Careful selection of w is required for the construction of concurrent spatial streams and parallel transmission of multiple users' data. Similarly, careful selection of w is required when generating blinding beams. As noted above, the most accurate and precise method, of constructing W from H to concurrently serve multiple users is known as dirty paper coding (DPC); however, in practice, this method is difficult to implement due to its complexity. Instead, other beamforming methods, and in particular, ZFBF, can be used to construct W. ZFBF is suboptimal for W construction compared to DPC, but it is simpler to implement while achieving performance almost equivalent to DPC when the AP has multiple antennas and each user has a single antenna. ZFBF also can be used effectively when computing a signal beam for an intended user and generally orthogonal blinding beams to thwart potential eavesdroppers. The STROBE system 200 uses ZFBF to select weights w for a signal beam and for one or more blinding beams such that the blinding beams cause zero inter-user interference with the signal beam. When computing the blinding beam steering parameters, the STROBE system 200 selects weights w, through ZFBF that establish a zero inter-user condition That is, the ZFBF algorithm produces the zero inter-user interference condition because the algorithm selects weights such that the dot product of the vectors h and w is zero. When the dot product of these vectors is zero, a beam generated with the selected steering weights w will by definition satisfy the zero inter-user interference condition. In practice, however, real-world effects may preclude actual transmission of zero interference beams. The optimal selection of W to satisfy this zero-interference condition is the pseudo inverse of H as shown in Equation (1):

W=H^{‡}=H*(HH*)⁻¹ Eq. (1)

The use of the pseudo-inverse is how the zero-interference condition is achieved: if W=H^{‡}, then hᵢwᵢ≠0 for i≠j. The matrix multiplication in Equation (1) places a limit on the maximum number of concurrent users (or spatial streams). Specifically, the number of concurrent streams (M) must be less than or equal to the number of transmit antennas (N).

In the STROBE system 200, the channel state information (CSI) for the intended user IU is fed back to the AP 160, as an h vector, in a manner analogous to the request to send/clear to send RTS/CTS exchange protocol provided in the IEEE 802.11ac and 802.11n standards. That is, a user 30 will refrain from sending a data frame (i.e., the CSI) to the AP 160 until the user 30 completes a RTS/CTS handshake with the AP 160. The user 30 initiates the process by sending a RTS frame. The AP 160 receives the RTS and responds with a CTS frame. The user 30 must receive a CTS frame before sending the CSI in a data frame. The CTS also contains a time value that alerts other users 30 to hold off from accessing the AP 160 while the user 30 initiating the RTS transmits its data. The RTS/CTS handshaking provides positive control over the use of the WLAN so as to minimize collisions among, users 30 and access points.

As noted, to provide security, the STROBE system 200 uses “orthogonal blinding,” which occurs, in parallel with signal transmissions to the intended user. Orthogonal blinding actively conceals the intended user's signal by overwhelming any potential eavesdroppers with blinding beams. The blinding beams are transmitted concurrently with the intended user's signal by the ZFBF-enabled transmitter using its remaining available streams. For example, in the system 100 of FIG. 2, the STROBE system 200 operates to send a signal to the intended user (IU) 30 using one of, the antenna 120 and to generate and transmit another three signals using the remaining three antenna 120. The blinding beams are constructed approximately orthogonally to the intended user's signal to ensure that these blinding streams cause the least possible decrease of the intended user's signal.

The beams used for the intended user (IU) and for blinding correspond to different w vectors, which come from the pseudo inverse of H. Thus, to construct orthogonal blinding streams, h vectors orthogonal to the intended user's h are generated, and then the STROBE system 200 performs ZFBF on the constructed H matrix. To construct these orthogonal h vectors, the STROBE system 200 retrieves the intended user's CSI (h₁), and pads h₁ with a truncated (M−1)×N identity matrix to build a preliminary H matrix. The STROBE system 200 then constructs the CSI matrix with orthogonal rows, \ddot{H}, by computing the pseudo-inverse of H. Thus, \ddot{H} is the pseudo-inverse of H. One known method for computing a pseudo-inverse of a matrix is the Gram-Schmidt process, which decomposes the H matrix into an upper triangular (R) and a unitary matrix (Q) before computing a orthonormalized set of vectors in an inner product space. That is, the Gram-Schmidt process takes a finite, linearly independent vector set H and computes orthogonal set \ddot{H} that spans the same k-dimensional subspace of as H.

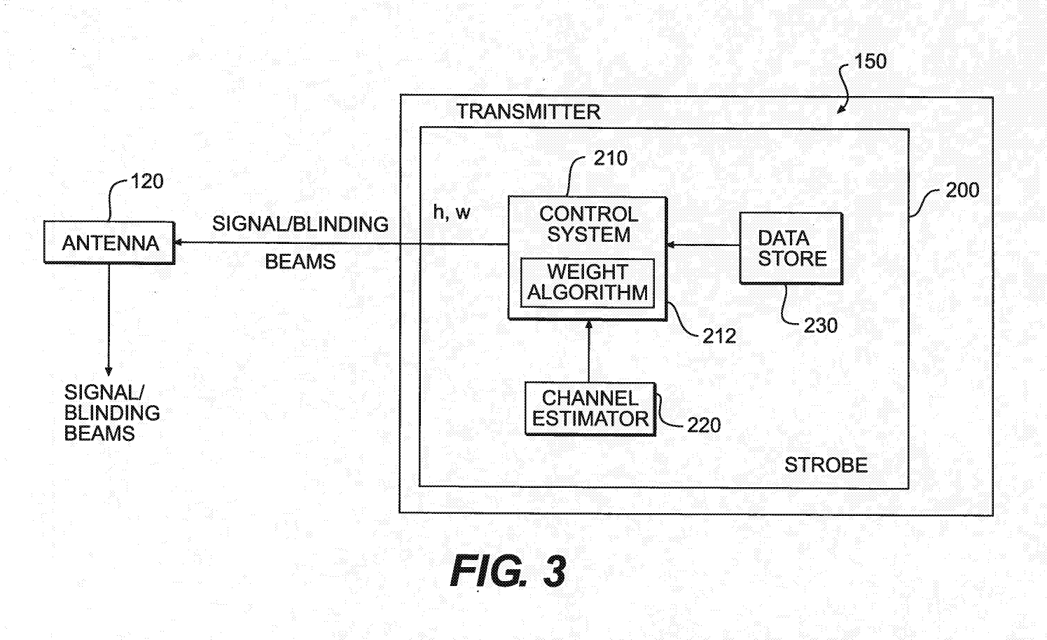

FIG. 3 is a block diagram of, an embodiment of the STROBE system 200 in relation to the access point components of the WLAN 100. In FIG. 3, WLAN 100 includes beamforming (ZFBF) transmitter 150 to which is coupled antenna 120, and which generates a ZFBF signal. The transmitter 150 includes STROBE system 200, which in turn includes control system 210. Coupled to the control j, system 210 is channel estimator 220 and data store 230. The transmitter 150, including the STROBE system 200 can be implemented in software, hardware, or firmware, or any combination thereof. The control system 210 executes the various algorithms to compute a ZFBF transmission and the blinding beams that are orthogonal to the ZFBF transmission. The control system 210, as noted above, may have the requisite algorithms and processes implemented in hardware. Alternately, the programming code may be stored in the data store 230 to be called and executed by the control system 210. In this alternative, the control system 210 functions as a programmable processor. The channel estimator 220 receives the CSI feedback signals from the users 30 and participates in the handshake process between a user 30 and the transmitter 150. The data store 230, as noted, may include programming code for execution by the control system 210. The data store 230 also may store data such as the CSI values. The data store 230 may be any computer-readable storage device, and may include volatile and non-volatile memory. The data store 230 may be implemented as a hard disk, a removable disk, or any current or future data storage device.

In operation, the control system 210 includes weight selection algorithm 212, which, in an embodiment, is a ZFBF algorithm, and in another embodiment is a DPC algorithm. The weight selection algorithm 212 computes beam steering weights that generate a set of blinding beams orthogonal to, or approximately orthogonal to, a desired signal beam to be sent to an intended user. Furthermore, the algorithm 212 computes the beam steering weights using only the channel state information for the intended user IU 30.

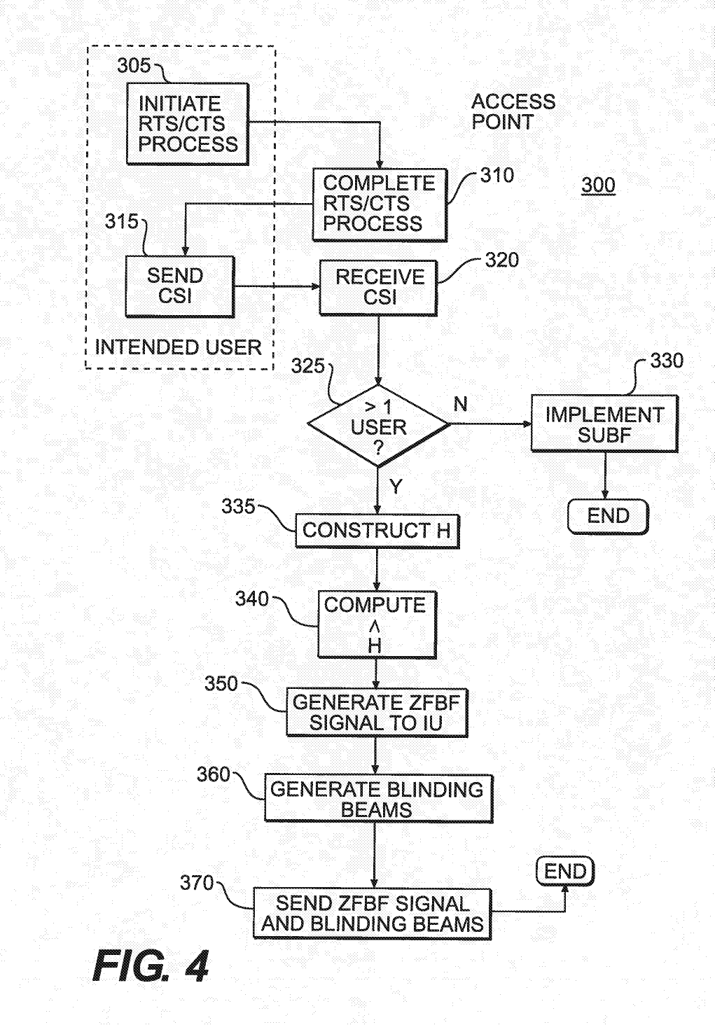

FIG. 4 is a flow chart illustrating an embodiment of an ZFBF operation of the STROBE system 200 in which communications security is enhanced by generation and transmission of orthogonal beams to frustrate attempts at eavesdropping a signal intended for a specific user. In FIG. 4, operation 300 begins in block 305 when intended user IU 30 initiates a connection protocol (e.g., RTS/CTS). In block 310, the transmitter 150 completes the handshake protocol. In block 315 the intended user IU 30 sends the CSI data to the AP 160, and in block 320, the channel estimator 220 receives and stores the CSI data.

In block 325, the control system 210 determines if there is more than one intended user (IU) 30 registered with the base station. If there is only one intended user (IU) 30 registered (no (N) in block 325), the method 300 moves to block 330, and the STROBE system 200 executes a SUBF scheme. However, if in block 325, the control system 210 determines that there is more than one registered intended user IU 30 (yes (Y)) the method 300 moves to block 335.

In block 335, the control system 210 computes H using the received CSI feedback from the intended users IU 30, and corresponding W to determine a zero inter-user interference condition. In block 340, the control system computes a CSI matrix with rows, H that are orthogonal to H by computing the pseudo-inverse of H. This CSI matrix provides the basis for determining the orthogonal “blinding stream” signals. In block 345, the control system 10 generates the ZFBF signal that is to be sent to the intended user IU 30, and in block 350 generates the orthogonal signals. In block 355, the transmitter 150 sends the ZFBF signal to the intended user IU 30 and in parallel, broadcasts the orthogonal signals. The method 300 then ends.

We claim:

1. A system for enhancing communications security in a wireless network, comprising:
a multiple antenna array arranged to transmit signals; and
a transmitter coupled to the multiple antenna array and configured with a beamformer to transmit the signals, the beamformer comprising:
a signal processor component that generates a transmit signal to an intended user using a spatial signal beam,
a blinding component that computes one or more blinding signals using spatial blinding beams having a zero inter-user interference condition with the spatial signal beam, and
a beamforming component that generates the signal and blinding beams, wherein the transmitter transmits the signal beam and the blinding beams simultaneously.

2. The system of claim 1, wherein the spatial signal beam and the spatial blinding beams are generated using channel information from only the intended user.

3. The system of claim 2, further comprising a ZFBF beamformer having a matrix inverse engine that computes a pseudo-inverse of a channel state information matrix to produce a steering weight matrix, wherein channel state information vectors in the channel state information matrix are obtained from only the intended user of the spatial signal beam.

4. the system of claim 1, wherein the beamformer approximates a dirty paper coding beamformer.

5. The system of claim 1, wherein the spatial signal beam and the spatial blinding beams are approximately orthogonal.

6. The system of claim 1, wherein there are multiple intended users, and wherein the beamformer generates transmit signals for each of the multiple intended users.

7. The system of claim 6, wherein each of the multiple intended users provides its own channel state information to the transmitter.

8. A wireless communications security method, comprising:
acquiring a wireless user in a wireless communications network, wherein the wireless user is an intended user;
receiving, channel state information from the intended user;
generating a signal beam to transmit data to the intended user;
generating one or more blinding beams based only on the channel state information from the intended user; and
transmitting simultaneously the signal beam and the one or more blinding beams.

9. The method of claim 8, wherein generating the one or more blinding beams comprises:
determining a channel vector and a corresponding channel matrix from the channel state information; and
determining one or more weighting vectors approximately orthogonal to the channel vector.

10. The method of claim 9, wherein the weighting vectors are generated using an approximation of dirty paper coding.

11. The method of claim 9, wherein the weighting vectors are determined using ZFBF.

12. The method of claim 8, wherein the wireless communications network comprises a second intended user, and wherein the method further comprises generating a second signal beam for transmission to the second intended user.

13. The method of claim 12, further comprising receiving channel state information from the second intended user.

14. The method of claim 8, wherein the signal beam and the blinding beams are approximately orthogonal.

15. A system for enhancing communications security in a wireless local area network (WLAN), comprising:
a multiple antenna array arranged to transmit and receive signals;
a transmitter/receiver coupled to the multiple antenna array and configured to transmit and receive the signals, the transmitter/receiver comprising a beamformer, the beamformer, comprising:
a signal processor component that generates a signal beam for transmission to an intended user, and
a blinding component that computes one or more blinding beams using only channel information of the intended user, the blinding beams having an approximately zero inter-user interference condition with the signal beam, wherein the transmitter/receiver transmits the signal beam and the blinding beams simultaneously.

16. The system of claim 15, wherein the beamformer is implemented in a PHY layer of an 802.11n/ac access point.

17. The system of claim 15, wherein the beamformer is a zero forcing beamformer.

18. The system of claim 17, wherein the zero forcing beamformer computes steering weights to generate the signal beam having the zero inter-user interference condition and computes weights orthogonal to the steering weights to generate the blinding beams.

19. The system of claim 15, wherein the WLAN operates in a range about 2.4 GHz.

20. The system of claim 15, wherein the antenna array comprises four transmit antennas.
